(19) United States
(12) Patent Application Publication
(10) Pub. No.: US 2009/0091660 A1
(43) Pub. Date: Apr. 9, 2009

(54) METHOD AND APPARATUS FOR PROCESSING COLOR COMPONENTS OF PIXEL THROUGH ADDING WHITE LIGHT ADAPTIVELY

(76) Inventors: Yu-Wei Wang, Hsinchu City (TW); Hsien-Che Lee, Tai-Chung City (TW)

Correspondence Address: NORTH AMERICA INTELLECTUAL PROPERTY CORPORATION, P.O. BOX 506, MERRIFIELD, VA, 22116, US

(21) Appl. No.: 11/868,542

(22) Filed: Oct. 8, 2007

(51) Int. Cl. H04N 9/64; H04N 9/68

(52) U.S. Cl. 348/649

(57) ABSTRACT

A method and an apparatus of processing a plurality of color components of a pixel are provided. The method includes: finding a maximum value of the color components; determining a scaling factor and an adjusting value according to the maximum value; and adjusting each of the color components according to a multiplication utilizing the scaling factor and an addition utilizing the adjusting value. The apparatus includes: a maximum value determining module, for finding a maximum value of the color components; a first adjustment control module, coupled to the maximum value determining module, for determining a scaling factor and an adjusting value according to the maximum value; and an adjusting module, coupled to the first adjustment control module, for adjusting each of the color components according to a multiplication utilizing the scaling factor and an addition utilizing the adjusting value.

### BACKGROUND

This invention relates to image processing, and more particularly, to a method and apparatus of processing color components of a pixel (e.g., RGB channels of a pixel) through adding white light adaptively.

Image capturing is commonly used in many fields, such as digital cameras. In generally, each color channel, R, G or B, of a captured pixel has 10 bits originally; however, the data range of the following signal processing stage permits 8 bits only. Therefore, clipping the output data is implemented. Please refer to FIG. 1, which is a diagram illustrating a conventional color clipping applied to output data. The horizontal axis represents the input data, and the vertical axis represents the output data generated from processing the input data through a typical white balance correction. In other words, the typical white balance correction applies a specific gain to the gray level of each color channel of the input data and then generated the output data. Due to the data range constrain, the gray level of a color channel R, G or B exceeding an upper limit of the data range is clipped. As shown in FIG. 1, the upper limit of the data range is 255 (starting with 0). In other words, the data range is delimited by 0 and 255, and includes, for example, 256 gray levels. When the input gray level of the color channel R reaches I_{R}, the color channel R of the output data becomes saturated due to the upper limit; similarly, when the input gray level of the color channel G reaches I_{G}, the color channel G of the output data becomes saturated, and when the input gray level of the color channel B reaches I_{B}, the color channel B of the output data becomes saturated. As the typical color clipping scheme clips the output gray level exceeding the upper limit directly, a discontinuous hue is perceptible to human eyes. For example, in a case where the input gray level of the R channel is greater than I_{R}, and input gray levels of G channel and B channel are less than I_{G} and I_{B} respectively, the actual output gray level of the R channel is saturated and kept at the upper limit (i.e., 255) due to applied color clipping, while the actual output gray levels of the G channel and B channel are not affected as respective saturation condition is not met yet. Because the actual output gray level of the R channel is deviated from the expected value, the blending of the color channels produces an adjusted color different than the expected color, degrading the image quality greatly. Therefore, a novel and improved color clipping scheme is required to solve above-mentioned problem.

### SUMMARY

It is therefore one of the objectives of the present invention to provide a method and apparatus of processing color components of a pixel (e.g., RGB channels of a pixel) by adding white light adaptively.

According to one embodiment of the present invention, a method of processing a plurality of color components of a pixel is disclosed. The method comprises: finding a maximum value of the color components; determining a scaling factor and an adjusting value according to the maximum value; and adjusting each of the color components according to a multiplication utilizing the scaling factor and an addition utilizing the adjusting value.

According to one embodiment of the present invention, an apparatus of processing a plurality of color components of a pixel is provided. The apparatus comprises: a maximum value determining module, for finding a maximum value of the color components; a first adjustment control module, coupled to the maximum value determining module, for determining a scaling factor and an adjusting value according to the maximum value; and an adjusting module, coupled to the first adjustment control module, for adjusting each of the color components according to a multiplication utilizing the scaling factor and an addition utilizing the adjusting value.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a conventional color clipping applied to output data.

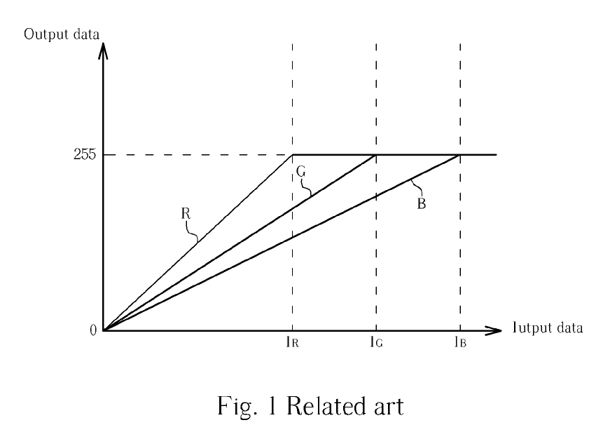

FIG. 2 is a simplified block diagram illustrating an apparatus configured for processing the color components of a pixel (e.g., RGB channels of a pixel) according to an embodiment of the present invention.

FIG. 3 is a detailed block diagram of an exemplary embodiment of an adaptive neutral delta module shown in FIG. 2.

FIG. 4 is a flowchart illustrating an adaptive scheme of determining a threshold value TP and a mapping function LUT associated with the threshold value TP.

FIG. 5 is a diagram illustrating an exemplary result of determining the threshold value TP and the mapping function LUT in step 412 shown in FIG. 4.

FIG. 6 is a diagram illustrating an exemplary result of determining the threshold value TP and the mapping function LUT in step 414 shown in FIG. 4.

FIG. 7 is a diagram illustrating an exemplary result of determining the threshold value TP and the mapping function LUT in step 416 shown in FIG. 4.

### DETAILED DESCRIPTION

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

Methods for processing color components of pixel through adding white light adaptively, or certain aspects or portions thereof, may take the form of program codes (i.e., instructions) embodied in tangible media, such as floppy diskettes, CD-ROMs, hard drives, or any other machine-readable storage medium, wherein, when the program codes are loaded into and executed by a machine, such as a mobile phone, a smart phone or the like, the machine becomes an apparatus for practicing the invention. The disclosed methods may also be embodied in the form of program codes transmitted over some transmission medium, such as electrical wiring or cabling, through fiber optics, or via any other form of transmission, wherein, when the program codes are received and loaded into and executed by a machine, such as a mobile phone, a smart phone or the like, the machine becomes an apparatus for practicing the invention. When implemented on a general-purpose processor, the program codes combine with the processor to provide a unique apparatus that operate analogously to specific logic circuits.

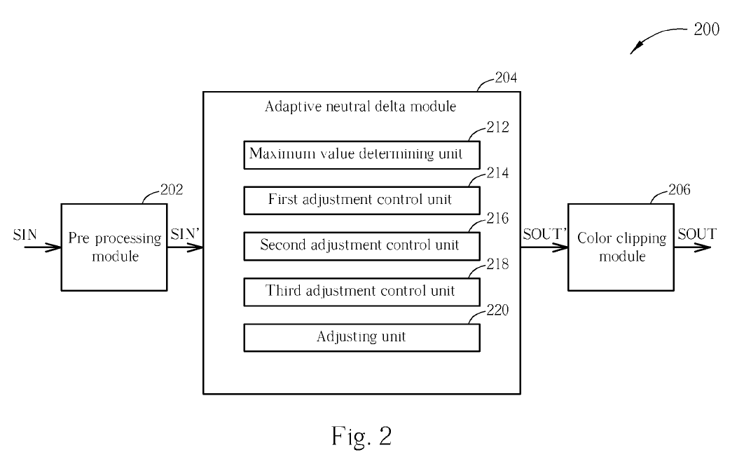

FIG. 2 is a simplified block diagram illustrating an apparatus 200 configured for processing color components of a pixel (e.g., RGB channels of a pixel) according to an embodiment of the present invention. As shown in FIG. 2, the apparatus 200 includes a pre-processing module 202, an adaptive neutral delta module 204, and a color clipping module 206. In this embodiment, the pre-processing module 202 serves as a gain stage for adjusting incoming source data SIN by setting gain values applied to different color components of each pixel, and then generates an input data SIN′ to the following adaptive neutral delta module 204. For example, the pre-processing module 202 in one embodiment of the present invention is a white balance correction module.

The adaptive neutral delta module 204 is used for adding a neutral delta value (i.e., white light) to each of the color components (i.e., RGB channels) according to an adaptive scheme. As shown in FIG. 2, the adaptive neutral delta module 204 includes a maximum value determining unit 212, a plurality of adjustment control units 214, 216, 218, and an adjusting unit 220. The maximum value determining unit 212 is configured to find out a maximum value among different color components of a pixel. The first adjustment control unit 214 is configured to determine a scaling factor and an adjusting value (i.e., a neutral delta value) according to the maximum value found by the maximum value determining unit 212. Additionally, the adjusting value is determined according to a non-linear mapping function. The adjusting unit 220 is configured to adjust each of the color components according to a multiplication utilizing the above scaling factor and an addition utilizing the above adjusting value. The second adjustment control module 216 is configured to compare the maximum value found by the maximum value determining unit 212 and a threshold value, and then select an output of the adjusting unit 220 or the received input date SIN′ as the output data SOUT′ according to a comparison result. In other words, the second adjustment control module 216 controls if the output data SOUT′ is the original input data SIN′ or an adjusted version of the input data SIN′ produced by the adaptive neutral delta module 204. The third adjustment control module 218 is configured to obtain a histogram of an image (e.g., a captured image generated from a CCD sensor module or CMOS sensor module) and then determine the above threshold value and mapping function according to the histogram adaptively. After receiving the output data SOUT′ from the preceding adaptive neutral delta module 204, the color clipping module 206 clips any gray value exceeding an upper limit of an permissible data range, and then outputs the resultant output data SOUT for following signal processing stages. Details of the adaptive neutral delta module 204 are given in the following paragraphs.

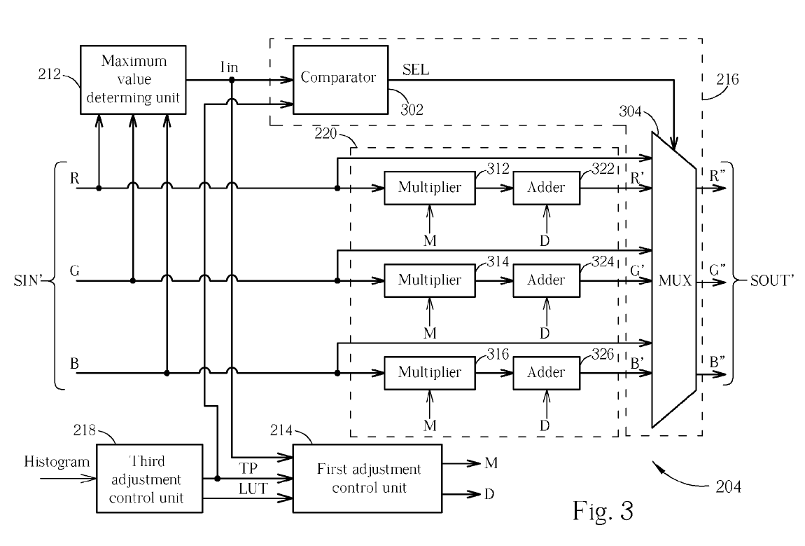

Please refer to FIG. 3. FIG. 3 is a detailed block diagram of an exemplary embodiment of the adaptive neutral delta module 204 shown in FIG. 2. In this embodiment, each pixel in the input data SIN′ includes gray values transmitted via RGB channels. In this embodiment, the second adjustment control unit 216 includes a comparator 302 and a multiplexer (MUX) 304; and the adjusting unit 220 includes a plurality of multipliers 312, 314, 316 and a plurality of adders 322, 324, 326. Suppose that the gray values R, G, B of a pixel in a captured image are inputted into the adaptive neutral delta module 204. The maximum value determining unit 212 is activated to find the maximum value Iᵢₙ among the received gray values R, G, B. The operation is represented as below:

Iᵢₙ=MAX(R,G,B) (1)

The maximum value determining unit 212 then outputs the found maximum value Iᵢₙ to the comparator 302 and the first adjustment control unit 214, respectively.

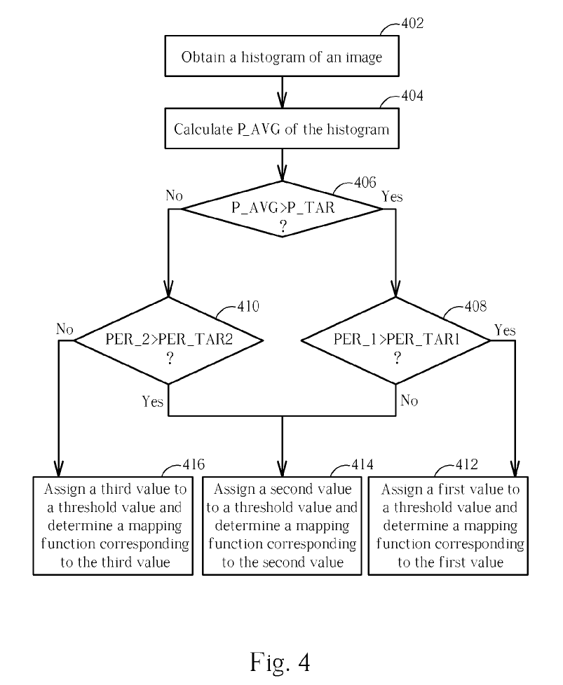

The third adjustment control unit 218 is responsible for determining a threshold value TP and a mapping function LUT associated with the threshold value TP. For example, the mapping function LUT describes relationship between the input data SIN′ and the output data SOUT′, in which a proportion of the output data SOUT′ to the input data SIN′ is lower than one when the input data SIN′ is greater than the threshold value TP, with a higher input data SIN′ corresponding to a lower or equal proportion. In a preferred embodiment, an adaptive scheme is applied to select the threshold value TP from a plurality of candidate threshold values and the mapping function LUT is selected from a plurality of candidate mapping functions. Please refer to FIG. 4, which is a flowchart illustrating an adaptive scheme of determining the threshold value TP and the mapping function LUT. Provided the result is substantially the same, the steps are not limited to be executed according to the exact order shown in FIG. 4. The flow of determining the threshold value TP and the mapping function LUT includes following steps:
Step 402: Obtain a histogram of an image in which the pixel to be processed is included.
Step 404: Calculate an average pixel value P_AVG corresponding to the histogram.
Step 406: Compare the average pixel value P_AVG with a target pixel value P_TAR. If the average pixel value P_AVG is greater than the target pixel value P_TAR, go to step 408; otherwise, go to step 410.
Step 408: Compare a first percentage PER_1 of pixels in the image that have pixel values greater than a first predetermined pixel value (e.g., 248) with a first target percentage PER_TAR1 (e.g., 0.5%). If the first percentage PER_1 is greater than the first target percentage PER_TAR1, go to step 412; otherwise, go to step 414.
Step 410: Compare a second percentage PER_2 of pixels in the image that have pixel values greater than a second predetermined pixel value (e.g., 248) with a second target percentage PER_TAR2 (e.g., 1%). If the second percentage PER_2 is greater than the second target percentage PER_TAR2, go to step 414; otherwise, go to step 416.
Step 412: Assign a first value (e.g., 255*0.95=242) to the threshold value TP and determine the mapping function LUT corresponding to the first value.
Step 414: Assign a second value (e.g., 255*0.85=216) to the threshold value TP and determine the mapping function LUT corresponding to the second value. The second value is smaller than the first value.
Step 416: Assign a third value (e.g., 255*0.55=140) to the threshold value TP and determine the mapping function LUT corresponding to the third value. The third value is smaller than the second value.

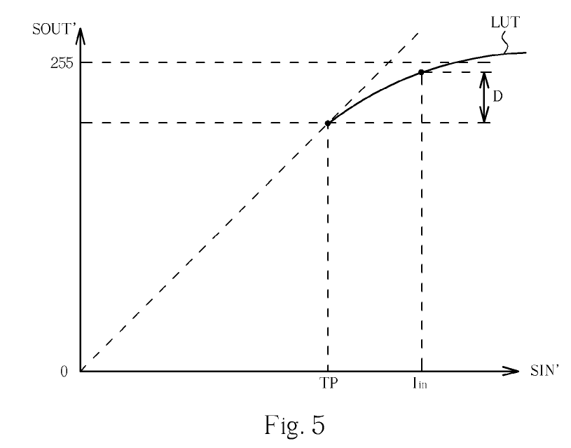

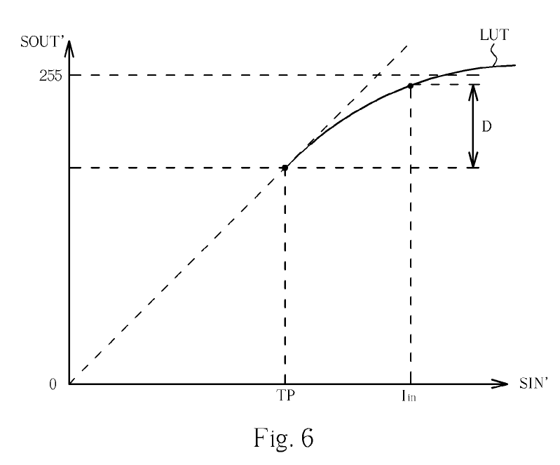

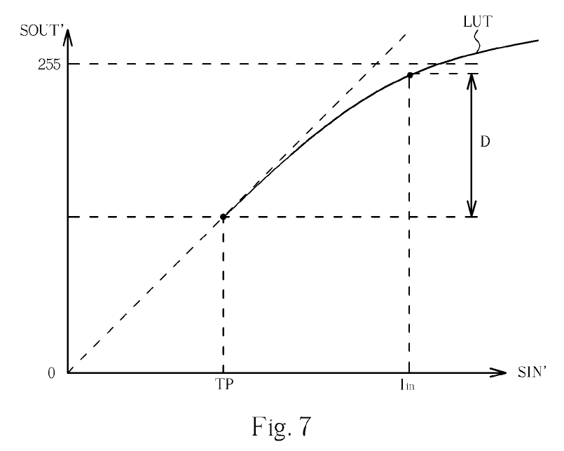

Exemplary results of determining the threshold value TP and the mapping function LUT in steps 412-416 are shown in FIGS. 5-7 respectively. The characteristic curve of the mapping function LUT is represented by a solid line starting from the threshold value TP. Referring to above description, a person skilled in this art can readily appreciate that the selection of the threshold value TP is based upon the luminance distribution of the image. That is, the brighter is the image, the greater the threshold value TP is. In this way, the image quality of the brighter image is not degraded due to the excessive adjustments made by the adaptive neutral delta module 204. Please note that the characteristic curve of the mapping function LUT can be established by any conventional means. For example, the non-linear characteristic curve can be estimated by a polynomial function as taught in the reference paper, “Dynamic Range Compression Preserving Local Image Contrast for Digital Camera”, IEEE 2005. Additionally, the characteristic curve can be built using N-segment piecewise linear table. The above is for illustrative purposes only, and is not meant to be taken as a limitation of the present invention.

As shown in FIG. 4, step 414 is executed when step 408 finds that the first percentage is not greater than the first target percentage or step 410 finds that the second percentage is greater than the second target percentage. However, sharing the same setting of the threshold value TP and the mapping function LUT is not meant to be a limitation of the present invention. In an alternative design, four settings of the threshold value TP and the mapping function LUT are implemented. For example, when the first percentage is greater than the first target percentage, the threshold value TP is set by a first value; when the first percentage is not greater than the first target percentage, the threshold value TP is set by a second value; when the second percentage is greater than the second target percentage, the threshold value TP is set by a third value; and when the second percentage is not greater than the second target percentage, the threshold value TP is set by a fourth value. Similarly, the first value is greater than the second value, the second value is greater than the third value, and the third value is greater than the fourth value. The same objective of determining an appropriate threshold value and an appropriate mapping function is achieved. After the threshold value TP and the mapping function LUT are determined, the first adjustment control unit 214 shown in FIG. 3 calculates the scaling factor M and the adjusting value (i.e., the neutral delta value) D according to the received maximum value Iᵢₙ. In this embodiment, the scaling factor M and the adjusting value D are set according to following equations.

M=TP/Iᵢₙ (2)

D=LUT(Iᵢₙ) (3)

The scaling factor M is generated by directly dividing the threshold value TP given by the third adjustment control unit 218 into the maximum value Iᵢₙ found by the maximum value determining unit 212. The adjusting value D is determined according to the mapping function LUT selected by the third adjustment control unit 218. Examples of the adjusting value D corresponding to the maximum value Iᵢₙ are depicted in FIGS. 5-7, respectively. As shown in FIG. 3, the same scaling factor M is sent to multipliers 312, 314 and 316, and the same adjusting value D is sent to adders 322, 324 and 326.

Next, the adjusting unit 220 uses the multipliers 312-316 and the adders 322-326 to adjust the gray values R, G, B of the input data SIN′ according to the scaling factor M and the adjusting value D. The computation of the adjusted gray values R′, G′, B′, as clearly indicated by following equations.

R′=R*M+D (4)

G′=G*M+D (5)

B′=B*M+D (6)

As stated above, the second adjustment control unit 216 controls if the output data SOUT′ is the original input data SIN′ directly or an adjusted version of the input data SIN′ produced by the adaptive neutral delta module 204. In this exemplary embodiment, the comparator 302 in the second adjustment control unit 216 compares the maximum value Iᵢₙ outputted from the maximum value determining unit 212 and the threshold value TP outputted from the third adjustment control unit 218 to generate a selection signal SEL to the multiplexer 304. That is, the selection signal SEL controls if the original input data SIN′ is bypassed and serves as the output data SOUT′ directly. When the maximum value Iᵢₙ reaches (exceeds or equals) the threshold value TP, meaning that the criterion of adding the neutral delta value (i.e., white light) to the input data SIN′ is met, the selection signal SEL then instructs the multiplexer 304 to output the adjusted gray values R′, G′, B′ as the gray values R″, G″, B″ of the output data SOUT′; otherwise, the selection signal SEL instructs the multiplexer 304 to output the original gray values R, G, B as the gray values R″, G″, B″ of the output data SOUT′ as the above criterion is not met.

Next, the color clipping module 206 processes the received output data SOUT′ and generate the resultant output data SOUT by clipping any gray values exceeding the upper limit of the data range. It should be noted that the same adjusting value (i.e., the neutral delta) is added to each color component by the adjusting unit 220. In this way, the aforementioned discontinuous hue caused by color clipping can be alleviated or eliminated, thereby achieving the greasy-highlight reduction and improving the image quality accordingly.

Additionally, if the mapping function LUT is well-defined to have a maximum output less than or equal to the upper limit of the permissible data range, the color clipping module 206 can be omitted. In short, the color clipping operation can be integrated into the mapping function LUT. In this way, when the adjusting value D is added to the color components of the input data SIN′, the adjusted color components are well-controlled to fall in the permissible range. As a result, the color clipping is needed no more.

Generally speaking, three color components of each pixel must exist simultaneously to precisely present an image. However, to simultaneously capture all three color components, the image system requires three individual image detectors for each pixel. This would be prohibitive due to the high cost and would cause the packaging to be very complex. To keep the size and cost of the image system to a minimum, an image sensor array must keep its size small as well. Therefore, the number of color samples must be kept low. An alternative approach is to make one pixel have a detector for gathering information for a single color component. Therefore, the image system typically uses a mosaic filter generally called a color filter array (CFA), and acquires a captured scene image by sampling one of the three different color components to obtain an array that stores only one color component per pixel. The image system gets a raw sensory data having less color samples per pixel because it ignores the other two color components for each pixel. Before the captured scene image is further processed or displayed, the missing color components of each pixel must be reconstructed so that each pixel contains all three color components as required. The process of reconstructing missing color components is commonly called demosaicking. When the disclosed color clipping control, realized by the combination of the adaptive neutral delta module 204 and the color clipping module 206, is applied to the image system mentioned above, it can be implemented to process pixel data in the raw data domain and/or RGB domain, depending upon design requirements. The pixels in the RGB domain have been processed by the above-mentioned demosaicking, and each pixel therefore contains three color components. Regarding the pixels in the raw data domain, they are not processed by the above-mentioned demosaicking yet. Therefore, each pixel in the raw data domain contains one color component only. In view of above description, applying the disclosed color clipping control to process the pixels in the RGB domain is self-explanatory. Further description is omitted here. Regarding the implementation of the disclosed color clipping control in the raw data domain, a slight modification is required. Taking a pixel in the raw data domain that has a gray value of the R channel for example, the adaptive neutral delta module 204 obtains missing gray values of the G channel and B channel through a simplified demosaicking scheme. Next, the aforementioned flow of processing the input data activated. Further description is omitted here for brevity. It should be noted that the output data SOUT of the color clipping module 206 includes one color component per pixel as the normal demosaicking operation is not executed yet. Preferably, the disclosed color clipping control is activated after the white balance correction has been applied to thereby guarantee that the adjustments made to color component(s) of each pixel will produce an adjusted image with correct hue as desired.

In the above exemplary embodiments, the adaptive neutral delta module 204 is dedicated to solving the problem caused by color clipping. However, this is not meant to be a limitation of the present invention. That is, any image processing applications using the adaptive neutral delta module and related method thereof to adjust the pixel data all fall in the scope of the present invention.

Briefly summarized, the disclosed adaptive neutral delta module adds “white light” to all of the color components of a pixel when there is one color component exceeding the permissible data range. As all of the color components are adjusted by the same amount of “white light,” the hue distortion is avoided or alleviated after the color clipping is applied. Additionally, an adaptive scheme is utilized for changing the setting of the threshold value used for judging if the saturation condition is met and the setting of the mapping function used for determining the amount of added “white light” according to image histogram information. In this way, the disclosed method of adding “white light” can meet image processing requirements of different scenes, for example, having different background luminance.

Furthermore, a multiplication using the same scaling factor is applied to each color channel, and an addition using the same adjusting value (i.e., the neutral delta value) is applied to each color channel, where the scaling factor is easily obtained through dividing the threshold value by the maximum value among the color components, and the adjusting value is easily obtained through referring to the mapping function. For pixels in the same image, the same mapping function and the same threshold value can be used repeatedly as the histogram of the image is not changed when each pixel in the image is processed. Therefore, implementation of the disclosed scheme of adding “white light” does not require many hardware resources, and can be easily integrated into any image processing systems.

Those skilled in the art will readily observe that numerous modifications and alterations of the device and method may be made while retaining the teachings of the invention.

What is claimed is:

1. A method of processing a plurality of color components of a pixel, comprising:
finding a maximum value of the color components;
determining a scaling factor and an adjusting value according to the maximum value; and
adjusting each of the color components according to a multiplication utilizing the scaling factor and an addition utilizing the adjusting value.

2. The method of claim 1, further comprising:
comparing the maximum value with a threshold value to select a result of adjusting each of the color components as an output or bypass the color components of the pixel as the output.

3. The method of claim 2, wherein the step of determining the scaling factor and the adjusting value comprises:
dividing the threshold value by the maximum value to determine the scaling factor.

4. The method of claim 2, wherein the step of determining the scaling factor and the adjusting value comprises:
determining the adjusting value according to a mapping function and the maximum value.

5. The method of claim 4, wherein the mapping function describes a relationship between input data and output data, in which a proportion of the output data to the input data is lower than one when the input data is greater than the threshold value.

6. The method of claim 4, further comprising:
obtaining a histogram of an image in which the pixel is included; and
determining the threshold value and the mapping function according to the histogram adaptively.

7. The method of claim 6, wherein the step of determining the threshold value and the mapping function comprises:
calculating an average pixel value corresponding to the histogram;
comparing the average pixel value and a target pixel value to generate a comparison result; and
determining the threshold value and the mapping function according to the comparison result.

8. The method of claim 6, wherein the step of determining the threshold value and the mapping function further comprises:
when the comparison result indicates that the average pixel value is greater than the target pixel value, comparing a first percentage of pixels in the image that have pixel values greater than a first pixel value with a first target percentage to generate a first comparison result; and
when the comparison result indicates that the average pixel value is not greater than the target pixel value, comparing a second percentage of pixels in the image that have pixel values greater than a second pixel value with a second target percentage to generate a second comparison result;
wherein the step of determining the threshold value and the mapping function according to the comparison result comprises:
determining the threshold value and the mapping function according to one of the first comparison result and the second comparison result.

9. The method of claim 8, wherein the step of determining the threshold value and the mapping function according to one of the first comparison result and the second comparison result comprises:
assigning a first value to the threshold value and determining the mapping function according to the first value when the first comparison result indicates that the first percentage is greater than the first target percentage, and assigning a second value less than the first value to the threshold value and determining the mapping function according to the second value; or
assigning a third value to the threshold value and determining the mapping function according to the third value when the second comparison result indicates that the second percentage is greater than the second target percentage, and assigning a fourth value less than the third value to the threshold value and determining the mapping function according to the fourth value when the second comparison result indicates that the second percentage is not greater than the second target percentage.

10. The method of claim 1, wherein the color components of the pixel have been pre-processed through a white balance correction.

11. The method of claim 10, further comprising:
applying color clipping to a result of adjusting each of the color components.

12. An apparatus of processing a plurality of color components of a pixel, comprising:
a maximum value determining unit, for finding a maximum value of the color components;
a first adjustment control unit, coupled to the maximum value determining unit, for determining a scaling factor and an adjusting value according to the maximum value; and
an adjusting unit, coupled to the first adjustment control unit, for adjusting each of the color components according to a multiplication utilizing the scaling factor and an addition utilizing the adjusting value.

13. The apparatus of claim 12, further comprising:
a second adjustment control unit, coupled to the maximum value determining unit, for comparing the maximum value with a threshold value to select a result of adjusting each of the color components as an output or bypass the color components of the pixel as the output.

14. The apparatus of claim 13, wherein the first adjustment control unit divides the threshold value by the maximum value to determine the scaling factor.

15. The apparatus of claim 13, wherein the first adjustment control unit determines the adjusting value according to a mapping function and the maximum value.

16. The apparatus of claim 15, wherein the mapping function describes a relationship between input data and output data, in which a proportion of the output data to the input data is lower than one when the input data is greater than the threshold value.

17. The apparatus of claim 15, further comprising:
a third adjustment control unit, coupled to the first adjustment control unit and the second adjustment control unit, for obtaining a histogram of an image in which the pixel is included, and determining the threshold value and the mapping function according to the histogram adaptively.

18. The apparatus of claim 17, wherein the third adjustment control unit calculates an average pixel value corresponding to the histogram, compares the average pixel value and a target pixel value to generate a comparison result, and determines the threshold value and the mapping function according to the comparison result.

19. The apparatus of claim 17, wherein when the comparison result indicates that the average pixel value is greater than the target pixel value, the third adjustment control unit compares a first percentage of pixels in the image that have pixel values greater than a first pixel value with a first target percentage to generate a first comparison result, and determines the threshold value and the mapping function according to the first comparison result; and when the comparison result indicates that the average pixel value is not greater than the target pixel value, the third adjustment control unit compares a second percentage of pixels in the image that have pixel values greater than a second pixel value with a second target percentage to generate a second comparison result, and determines the threshold value and the mapping function according to the second comparison result.

20. The apparatus of claim 19, wherein the third adjustment control unit assigns a first value to the threshold value and determines the mapping function according to the first value when the first comparison result indicates that the first percentage is greater than the first target percentage and, and assigns a second value less than the first value to the threshold value and determines the mapping function according to the second value when the first comparison result indicates that the first percentage is not greater than the first target percentage; or the third adjustment control unit assigns a third value to the threshold value and determines the mapping function according to the third value when the second comparison result indicates that the second percentage is greater than the second target percentage, and assigns a fourth value less than the third value to the threshold value and determines the mapping function according to the fourth value when the second comparison result indicates that the second percentage is not greater than the second target percentage.

21. The apparatus of claim 12, further comprising:
a white balance correction module, coupled to the maximum value determining unit, the first adjustment control unit, and the adjusting unit, for generating the color components of the pixel.

22. The apparatus of claim 21, further comprising:
a color clipping module, coupled to the adjusting unit, for applying color clipping to a result of adjusting each of the color components by the adjusting unit.
